(19) United States
(12) Patent Application Publication
(10) Pub. No.: US 2021/0185596 A1
(43) Pub. Date: Jun. 17, 2021

(54) NETWORK REPORTING IN A CELLULAR NETWORK

(71) Applicant: JRD Communication (SHENZHEN) LTD, Nanshan Shenzhen, Guangdong (CN)

(72) Inventors: Benny ASSOULINE, Colombes (FR); Guang LIU, Colombes (FR)

(21) Appl. No.: 16/636,869

(22) PCT Filed: Sep. 5, 2019
(86) PCT No.: PCT/CN2019/104586

§ 371 Date: Feb. 5, 2020

(30) Foreign Application Priority Data
Sep. 6, 2018 (GB) 1814539.1

(51) Int. Cl. H04W 48/16; H04W 48/10; H04W 24/10

(52) U.S. Cl. CPC H04W 48/16; H04W 24/10; H04W 48/10

(57) ABSTRACT

Methods for instructing and communicating measurements of neighbouring cells in a cellular communication network. Mobile devices may be instructed to take measurements using a broadcast or dedicated measurement instruction. The instruction may include white and black lists to define which cells a mobile device should report on.

### TECHNICAL FIELD

The following disclosure relates to reporting in a cellular network, and in particular to Self Organising Network (SON) reporting from a UE to a base station.

### BACKGROUND

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards a broadband and mobile system.

FIG. 1 shows a schematic diagram of an example of three base stations forming a cellular network. In cellular wireless communication systems User Equipment (UE) is connected by a wireless link to a Radio Access Network (RAN). The RAN comprises a set of base stations which provide wireless links to the UEs located in cells covered by the base station, and an interface to a Core Network (CN) which provides overall network control. As will be appreciated the RAN and CN each conduct respective functions in relation to the overall network. For convenience the term cellular network will be used to refer to the combined RAN & CN, and it will be understood that the term is used to refer to the respective system for performing the disclosed function.

The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a next generation NodeB (gNB). NR is proposed to utilise an Orthogonal Frequency Division Multiplexed (OFDM) physical transmission format.

One trend in wireless communications is towards the provision of lower latency and higher reliability services. For example, NR is intended to support Ultra-reliable and low-latency communications (URLLC) for small packet sizes (typically 32 bytes), A user-plane latency of 1 ms has been proposed with a reliability of 99.99999%, and at the physical layer a packet loss rate of 10⁻⁵ or 10⁻⁸ has been proposed. Another trend is toward supporting massive machine type communications (mMTC) where a typical mMTC application is considered to be delay tolerant, power consumption sensitive and complexity/cost sensitive, mMTC applications can be deployed in relatively bad radio conditions and may need to support extended coverage techniques.

mMTC services are intended to support a large number of devices over a long life-time with highly energy efficient communication channels, where transmission of data to and from each device occurs sporadically and infrequently. For example, a cell may be expected to support many thousands of devices. mMTC services are thus relevant to Internet of Things (IoT) applications. A further standard relating to IoT is Narrowband IoT (NB-IoT) which uses a single narrow-band of 200 kHz. NB-IoT is intended to support high connection densities with a particular focus on indoor coverage, and low cost & power consumption.

Self Organising Network (SON) technology may be utilised to assist in the deployment and running of cellular networks to reduce manual configuration requirements. A particular aspect of SON in cellular networks is Automatic Neighbour Relation (ANR) which enables a cell to identify neighbouring cells, which information may be useful in autonomous Physical cell identification setting, determining hand-over candidates and in other aspects of the NW maintenance and configuration.

In conventional systems a four step process is utilised in ANR for UEs to acquire information on neighbouring cells and transmit that information to the network. The network first configures a UE with a dedicated configuration message to acquire measurements and the UE acquires the Physical Layer Cell ID (PCI) and signal levels of cells which it can detect. The UE reports these to the network and the network may then request an additional report for a specific PCI. The UE then reads the System Information (SI) of the indicated PCI and reports back to the network.

This four step process may be more complex if applied in an NB-IoT system as measurements can only be taken in idle mode, but the dedicated configuration message and UE reports can only be sent while in connected mode. The UE must thus transition between states to enable the process to be completed, which is inefficient in terms of both signalling overhead and power consumption.

There is therefore a requirement for an improved measurement system, particularly for NB-IoT systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a method of reporting cell information, the method performed by a mobile device in communication with a base station of a cellular communications network and comprising the steps of receiving a measurement instruction at the mobile device from the base station; detecting signals while not connected to the base station from at least one cell that is not currently serving the mobile device and ascertaining the identity of the at least one cell; comparing the identity of the at least one cell to a black list of cells on which the mobile device is requested not to report; acquiring the System Information from at least one cell which is not in the black list of cells; establishing a connection to the base station; and reporting information on at least one of the cells not in the black list of cells.

The measurement instruction may be received while the mobile device is in idle mode.

The measurement instruction may be received in a broadcast message.

The measurement instruction may be received in a System Information broadcast from the base station.

The measurement instruction may be received while the UE is in connected mode.

The measurement indication may be received in a dedicated message to the mobile device.

The dedicated message may be an RRC message.

The RRC message may be included in an RRCConnectionRelease message.

The UE may release the connection after receiving the measurement instruction and prior to the step of detecting signals.

The measurement instruction may comprise the black list.

The method may further comprise comparing the identity of the at least one cell to a white list of cells on which the mobile device is requested to report.

The measurement instruction may comprise the white list.

The mobile device may only acquire system information for cells in the white list, or the mobile device prioritises acquiring system information for cells in the white list.

The method may further comprise comparing the power and/or the quality of the detected signals to a respective threshold, and only reporting information on a cell if the measured signal power and/or quality is greater than the configured threshold.

The mobile device may report information on the cell with the highest power that is not in the black list.

The mobile device may only report information on cells in the white list, or the mobile device prioritises reporting information for cells in the white list.

A specific black list may be provided for intra frequency cells, inter frequency cells, and/or inter RAT which may be detected.

A specific black list may be provided for at least one specific frequency.

A specific black list may be provided for inter RAT cells which may be detected.

The steps of receiving, detecting, comparing, and acquiring may be performed while the mobile device is in an idle state.

The method may be initiated in response the mobile device transitioning to an active state for a purpose unrelated to measurements.

The cell identity may be the physical cell identity and the reported information includes at least one of PCI, ECGI, TA and PLMN ID.

The step of detecting signals may be performed at frequencies previously indicated for cell reselection in a System Information message.

The black list may be all, or a subset of, a black list received in a System Information message.

The System Information message may be an SIB4-NB, SIB5-NB, or SIB7-NB.

The mobile device may only report information for the strongest power and/or strongest quality detected cell(s) which comply with the measurement instruction.

The black list may be empty and the mobile device reports at least one of PCI, ECGI, TA and PLMN ID for the strongest cell of each frequency which meets a signal power and/or quality threshold.

There is also provided a method of obtaining cell information, the method performed by a base station in a cellular communication network and comprising the steps of transmitting a measurement instruction in a system information broadcast message comprising at least a black list of cells on which information is not required; and receiving information related to at least one cell not on the black list from a UE which received the system information broadcast message.

The broadcast message may further comprise a white list of cells on which information is requested.

In another aspect, there is provided a non-transitory computer-readable medium. The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale. Like reference numerals have been included in the respective drawings to ease understanding.

FIG. 1 shows an example of a cellular communications network; and

FIG. 2 shows a flow chart for reporting measurement information.

### DETAILED DESCRIPTION OF THE PREFERRED EMBODIMENTS

Those skilled in the art will recognise and appreciate that the specifics of the examples described are merely illustrative of some embodiments and that the teachings set forth herein are applicable in a variety of alternative settings.

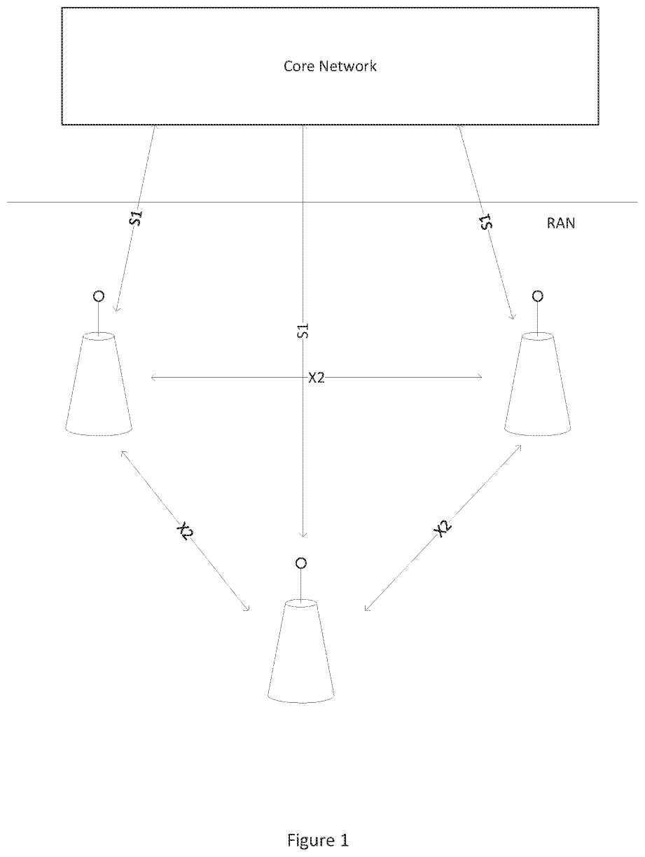

FIG. 1 shows a schematic diagram of three base stations (for example, eNB or gNBs depending on the particular cellular standard and terminology) forming a cellular network. Typically, each of the base stations will be deployed by one cellular network operator to provide geographic coverage for UEs in the area. The base stations form a Radio Area Network (RAN). Each base station provides wireless coverage for UEs in its area or cell. The base stations are interconnected via the X2 interface and are connected to the core network via the S1 interface. As will be appreciated only basic details are shown for the purposes of exemplifying the key features of a cellular network.

The base stations each comprise hardware and software to implement the RAN's functionality, including communications with the core network and other base stations, carriage of control and data signals between the core network and UEs, and maintaining wireless communications with UEs associated with each base station. The core network comprises hardware and software to implement the network functionality, such as overall network management and control, and routing of calls and data. For convenience the term UE will be used to refer to all types of mobile device.

The following disclosure provides methods for UEs to obtain network information and transmit that information to the network. The methods seek to improve power consumption and reduce signalling overhead compared to convention techniques.

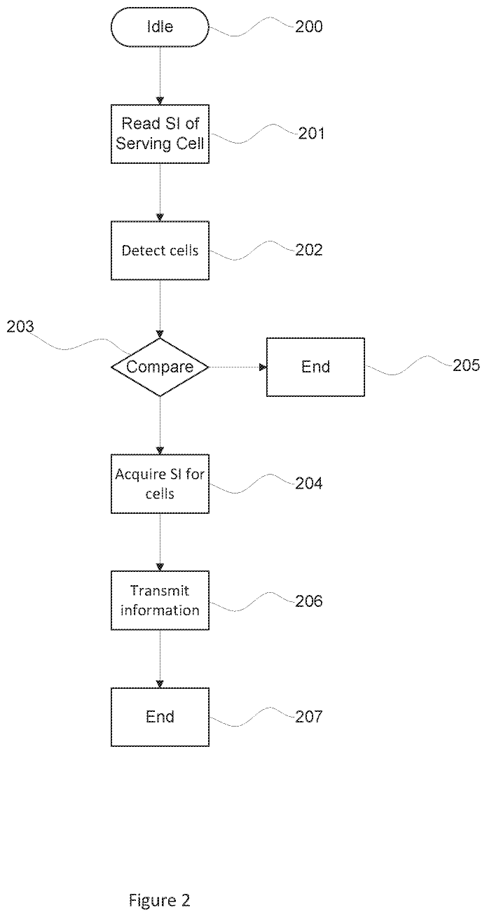

FIG. 2 shows a flow chart of a method for obtaining network information, commencing at step 200 with a UE in idle mode (RRC_IDLE) connected to a base station.

At step 201 the UE reads the System Information (SI) configuration from its serving cell. Step 201 may be initiated by the UE waking up (i.e. transitions to an active state) for another purpose, for example to initiate a mobile originating (MO) call, or for a data transmission.

The received SI transmission includes a set of details regarding measurements that the base station wishes to be performed by UEs receiving the SI transmission. That is, the SI is used as a broadcast signal to request measurements for UEs in the cell.

In a particular example the SI includes a white list and a black list of PCIs (or other cell identifiers). These lists provide information to the UE on how to report detected PCIs to the network. In an example, PCIs appearing on the white list should, assuming they can be detected in a useful manner, always be reported to the network, while PCIs appearing on the black list should not be reported to the network.

Utilising the SI for communicating this information to the UE allows the UE to remain in idle mode and to be directed to cells on which the network requires information, thus reducing unnecessary signalling. For example, a base station may have recent information regarding a particular PCI and does not thus require any further information. The PCI may be included in the black list and the UE will not transmit any information regarding that cell to the network.

Conversely a base station may have old or limited information on a particular PCI, or may become aware of a new PCI joining the network, in which case the PCI can be placed in the white list such that any UE which detects that PCI is required to report its results.

At step 202 the UE performs measurements to detect neighbouring cells, At this stage the UE may detect a limited set of information (for example, only PCI and signal power, or only PCI). At step 203 the UE compares the detected PCIs to the white and black lists. Any Pas in the black list are ignored, and for any PCIs in the white list the UE may continue to step 204 to acquire further information for those cells. For example, the UE may acquire the SI for all cells in the white list. Alternatively, the UE may acquire further information on the white listed cell with the highest detected power.

In a first option, the UE may be configured (for example, via the SI from the serving cell) to obtain further information on any cells not in either list, or not to acquire further information on such cells.

If the UE has not detected any cells which require further information to be obtained the process ends at step 205 and the UE returns to its previous function (for example, initiating an MO call).

At step 206 the UE transitions to the connected state and transmits the obtained information to the base station. The base station may then utilise that information as appropriate, for example in an ANR process. At step 207 the UE ends the measurement process and returns to its previous function.

In the method of FIG. 2 the UE only has to transition to the connected state once, as opposed to twice for the conventional method, and only report transmission is required compared to two in the conventional method. Furthermore, once connected the UE may use that connection for the process for which it was waking up and hence there is no additional connection process. The method of FIG. 2 thus provides improved efficiency for detecting and transmitting information to the network. Also, the configuration signalling is a broadcast signal and may thus be more efficient than dedicated signalling sent to many UEs.

The broadcast SI may also include signal power or quality thresholds such that a UE only provides a report on PCIs which exceed the relevant threshold. The SI may include measurement indications for some or all of intra-frequent, inter-frequency, and inter-Radio Access Technology (RAT) cells. The indications may be the same or different for each type of cell.

The network may reuse the SIB4-NB for INTRA-frequency neighbouring cells ANR configuration on top of the information used for intra frequency cell reselection if any:—
a. SIB4-NB may include a black list of cell physical identities for ANR reporting.
b. SIB4-NB may include a white list of cell physical identities for ANR reporting.
c. SIB4-NB may include signal power and/or signal quality thresholds for ANR reporting.

The NW may reuse SIB-5 for INTER-frequency neighbouring cells ANR configuration on top of the information used for inter-frequency cell reselection if any
a. SIB5-NB may include a black list of cell physical identities for ANR reporting,
b. SIB5-NB may include a white list of cell physical identities for ANR reporting.
c. SIB5-NB may include signal power and/or signal quality thresholds for ANR reporting.

The NW may reuse SIB-7 for INTER-RAT GERAN neighbouring cells ANR configuration on top of the information used for inter-RAT cell reselection if any
SIB7-NB may include a black list of cell physical identities for ANR reporting.
b. SIB7-NB may include a white list of cell physical identities for ANR reporting.
c. SIB7-NB may include signal power and/or signal quality thresholds for ANR reporting.

For the inter-frequency or inter-RAT case, the white list and/or black list may be provided per frequency.

The requirement for measurements may be indicated in the SI by the inclusion of at least one of the white list or black list. This avoids the need for a separate indication that measurements are required. Either list may be included as an empty list, thus requesting measurements, but without any restriction of the cells to report or not report.

Alternatively, the request for measurements can be signalled with a specific indication. For intra frequency there can be an ANR request indication in SIB4-NB. For inter frequency and inter RAT there could be an indication in SIB5-NB and SIB-7 NB. The indication for inter frequency and inter RAT may apply for all the carrier frequencies that are listed in SIB5-NB and SIB7-NB respectively. Alternately there could be a specific ANR request indication per carrier frequency in either SIB5-NB or SIB7-NB respectively.

Existing signalling may be re-used to provide the black list of cell identities, either alone or in combination with specific signalling.
a. For Intra-frequency, the black list may be a superset of the PCIs included in intraFreqBlackCellList, intraFreqNeighCellList, and a new list dedicated for measurements and ANR reporting e.g. intraFreqANRBlackCellList,
b. For Inter-frequency the black list may be provided per frequency. It could be a superset of the PCIs included in any of interFreqNeighCellList, interFreqBlackCellList, and a new list dedicated for measurements and ANR reporting e.g. interFreqANRBlackCellList.
c. For GERAN Inter RAT frequency the black list may be provided per frequency. Since there is no existing signalling that can be reused, a new list may be defined e.g. ANRBlackCellListGERAN

If a UE receives a white list, it may measure and provide details only for cells in that white list. Alternatively, the UE may also provide details for cells which are not in either the white list or the black list, or the UE may provide details for cells which are not in either list only if no white listed cells are detected.

The UE may report details only for the strongest (in power or quality) detected cells which comply with the measurement indications received from the base station. This applies particularly for the inter-frequency or inter-RAT cases.

As set out above, the measure processes are performed while the UE is in RRC_IDLE mode, but are typically performed immediately prior to the UE establishing a connection for another purpose. The closer the measurement is taken to the establishment time, the more relevant that measurement that may be. The UE may include an indication of the time at which the measurement was taken with the information.

Typically the measurement process is triggered by an unrelated process which has initiated connection establishment. The availability of a report is not typically a trigger for establishing a connection and transmitting a report, but such a configuration could be implemented if required. Also, connection establishment for mobile terminating calls or data may, or may not, act as a trigger to measure and transmit a report.

In the process described above, the indication to conduct measurements and transmit a report is sent using a broadcast message. All UEs in the relevant cell may thus perform the measurements and transmit a report. This may lead to duplication of measurements and reporting, for example in a situation in which a new PCI is detected by a number of UEs. This may be avoided by using dedicated signalling, for example an RRC message, such that only a subset of UEs are configured to take measurements provide reports. All aspects described in relation to FIG. 2 above apply in the same way to this example, with the only difference being that at step 201 a dedicated (RRC) message to instruct measurements is received while the UE is in connected mode, rather than the information being taken from the SI while in idle mode.

The measurement instruction at Step 201 may be provided as a dedicated message in a SIB4-NB container, SIB5-NB container and SIB7-NB container, included in an RRCConnectionRelease message. The RRCConnectionRelease message may include a ReleaseCause to indicate ANRReporting. Once the measurement instruction is received the UE releases the connection to continue the method in idle mode.

In such case, upon leaving RRC_CONNECTED the UE performs the required measurements and system information acquisition described above with reference to steps 202 and 205, and provides the report to the lower layer for transmission (which would trigger a connection establishment with the NW).

The network may configure a timeout for reporting measurements. The UE may perform measurements as soon as it enters RRC_IDLE, and then waits for a connection establishment for another purpose to transmit the information as described above. If the timeout expires before such a connection establishment is triggered the data may be discarded, or a connection may be established to transmit the information.

A combination of broadcast and dedicated signalling may be utilised, such that the dedicated signalling can be used to override the broadcast signalling for certain UEs from which specific behaviour is requested.

In an example use of the methods described above, a new base station (for example an eNB) may be deployed into a network. The eNB may include in its SI broadcast (or dedicated signalling) an empty black list and no white list. This may be included for one or more of intra-frequency cells, inter-frequency cells, and inter-RAT frequencies.

Since UEs are not provided with any cell identifies in the black list or white list, it would report back at least one of PCI, ECGI, TA and PLMN ID for the strongest cell of each frequency, as long as it fulfils the signal power/quality threshold. As set out above, the UEs may also be configured to transmit information for more than only the strongest cell.

In a variation of the methods described above, the UE may compare detected PCIs sequentially to the black and white lists. That is, once a first PCI has been detected it is compared to the lists. If the UE should report that PCI the UE stops searching for further cells and The UE can continue and search for additional cells.

In practice, As the eNB populates the neighbouring cells list, it needs less and less reports since there are less unknown neighbours and if the eNB include all the cells it is familiar with in the black lists then most of the reports would be void and would not be transmitted at all.

If a base station is aware of a PCI range that is used for a special purpose, e.g. For CSG cells, and the base station is not interested in ANR reports for this PCI range, it may include that PCI range in the configured black list. The white and black lists may, in general, be provided in the form of individual identities, or ranges.

A base station may maintain a timestamp for each cell it is aware of to indicate the last time that cell seen. The cell may be removed from the base station's neighbouring cell map if the cell has not been seen before a threshold time. The base station may be configured to add cells to the white list as the threshold time approaches for each cell such that the data is refreshed and the cell is maintained in the cell map. UEs receiving the white list would thus prioritise detected those cells.

The white list may also be used to prioritise specific cells to compile an RSRQ/RSRP map of a cell (e.g. to support positioning functionality or in order to optimize inter-cell interference), For this case too, the base station may decide to add known cell PCIS to the white list, to get multiple ANR reports for that cell from multiple UEs in different locations within the serving cell.

PCI has been used as an example identifier, but other identifiers for a cell of eNB may be utilised and reported. Other parameters, such as TA and PLMN ID may also be reported.

In variations of the methods disclosed herein, the black list may not be transmitted and the UE may perform its methods without comparison to a black list. In such a situation information from all measurements may be transmitted, or information from a subset of measurements as determined by application of the rules discussed herein such as comparison to thresholds.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor comprising the computer system to cause the processor to perform specified operations. Such instructions, generally 45 referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may comprise at least one from a group consisting of; a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organisation.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognise that various features of the described embodiments may be combined in accordance with the invention. In the claims, the term ‘comprising’ or “including” does not exclude the presence of other elements.

1-31. (canceled)

32. A method of reporting cell information, the method performed by a mobile device in communication with a base station of a cellular communications network and comprising the steps of
receiving a measurement instruction at the mobile device from the base station;
detecting signals while not connected to the base station from at least one cell that is not currently serving the mobile device and ascertaining the identity of the at least one cell;
comparing the identity of the at least one cell to a black list of cells on which the mobile device is requested not to report;
acquiring the System Information from at least one cell which is not in the black list of cells;
establishing a connection to the base station;
reporting information on at least one of the cells not in the black list of cells; and
comparing the power and/or the quality of the detected signals to a respective threshold, and only reporting information on a cell if the measured signal power and/or quality is greater than the configured threshold,
wherein the mobile device reports information on the cell with the highest power that is not in the black list.

33. The method according to claim 32, wherein the measurement instruction is received while the mobile device is in idle mode.

34. The method according to claim 32, wherein the measurement instruction is received in a broadcast message.

35. The method according to claim 32, wherein the measurement instruction is received while the UE is in connected mode.

36. The method according to claim 35, wherein the measurement indication is received in a dedicated message to the mobile device.

37. The method according to claim 36, wherein the dedicated message is an RRC message.

38. The method according to claim 37, wherein the RRC message is included in an RRCConnectionRelease message.

39. The method according to claim 32, wherein the measurement instruction comprises the black list.

40. The method according to claim 32, further comprising comparing the identity of the at least one cell to a white list of cells on which the mobile device is requested to report.

41. The method according to claim 40, wherein the measurement instruction comprises the white list.

42. The method according to claim 40, wherein the mobile device only acquires system information for cells in the white list, or the mobile device prioritises acquiring system information for cells in the white list.

43. The method according to claim 32, wherein the mobile device only reports information on cells in the white list, or the mobile device prioritises reporting information for cells in the white list.

44. The method according to claim 32, wherein a specific black list is provided for intra frequency cells which may be detected, at least one specific frequency, and/or inter RAT cells which may be detected.

45. The method according to claim 32, wherein a specific black list is provided for inter frequency cells which may be detected.

46. The method according to claim 32, wherein the steps of receiving, detecting, comparing, and acquiring are performed while the mobile device is in an idle state.

47. The method according to claim 32, wherein the method is initiated in response the mobile device transitioning to an active state for a purpose unrelated to measurements.

48. The method according to claim 32, wherein the cell identity is the physical cell identity and the reported information includes at least one of PCI, ECGI, TA and PLMN ID.

49. The method according to claim 32, wherein the step of detecting signals is performed at frequencies previously indicated for cell reselection in a System Information message.

50. The method according to claim 32, wherein the black list is all, or a subset of, a black list received in a System Information message.

51. The method of obtaining cell information, the method performed by a base station in a cellular communication network and comprising the steps of transmitting a measurement instruction in a dedicated message comprising at least a black list of cells on which information is not required;
receiving information related to at least one cell not on the black list from a UE which received the dedicated message; and
signal power or quality threshold is included by the base station.
